(19) United States
(12) Patent Application Publication
(10) Pub. No.: US 2010/0082371 A1
(43) Pub. Date: Apr. 1, 2010

(54) Patient Document Privacy And Disclosure Engine

(75) Inventors: Daniel Gary Kamp, Barrington, IL (US); Trivedi Kumar Bodlapati, Bangalore (IN)

Correspondence Address: MCANDREWS HELD & MALLOY, LTD, 500 WEST MADISON STREET, SUITE 3400, CHICAGO, IL, 60661, US

(73) Assignee: GENERAL ELECTRIC COMPANY, A NEW YORK CORPORATION, Schenectady, NY (US)

(21) Appl. No.: 12/243,492

(22) Filed: Oct. 1, 2008

(51) Int. Cl. G06Q 50/00

(52) U.S. Cl. 705/3; 705/2

(57) ABSTRACT

A system and method is provided for managing health care information. A data network system includes a document parser, upon request, parses a patient's record into a plurality of categorized biographical and/or clinical data entries, where each of the categorized biographical and/or clinical data entries may be associated with a code identifier. A mapper may map each of the code identifiers to a configurable patient privacy flag and to a corresponding user permission level. The patient's mapped categorized biographical and/or clinical data entries may be checked by a configurable rule engine, and be displayed to the user as viewable layers with the same or less restrictive permission level than that of the user's role. The unapproved data may be turned off as non-viewable layers. The patient's mapped biographical and/or clinical data entries may be stored into a repository database for later retrieval.

### CROSS-REFERENCE TO RELATED APPLICATIONS/INCORPORATION BY REFERENCE

Not Applicable

### FIELD OF THE INVENTION

Certain embodiments of the invention relate to patient document privacy and disclosure engine. More specifically, certain embodiments of the invention relate to a method and system for a patient document privacy and disclosure engine to parse patient's personal and clinical data from a document upon a request or for later access. Contents requested may be visible in part or in entirety based on the requester's permission level.

### BACKGROUND OF THE INVENTION

The Health Insurance Portability and Accountability Act (HIPAA) were enacted by the U.S. Congress in 1996. Title II of HIPAA, the Administrative Simplification (AS) provisions, requires the establishment of national standards for electronic health care transactions and national identifiers for providers, health insurance plans, and employers. The AS provisions also address the security and privacy of health data. The standards are meant to improve the efficiency and effectiveness of the nation's health care system by encouraging the widespread use of electronic data interchange in the US health care system.

Title II of HIPAA defines numerous offenses relating to health care and sets civil and criminal penalties for them. Title II requires the Department of Health and Human Services (HHS) to draft rules aimed at increasing the efficiency of the health care system by creating standards for the use and dissemination of health care information. These rules apply to “covered entities” as defined by HIPAA and the HHS. Covered entities include health plans, health care clearinghouses, such as billing services and community health information systems, and health care providers that transmit health care data in a way that is regulated by HIPAA.

A covered entity may disclose Protected Health Information (PHI) to facilitate treatment, payment, or health care operations or if the covered entity has obtained authorization from the individual. However, when a covered entity discloses any PHI, it must make a reasonable effort to disclose only the minimum necessary information required to achieve its purpose.

Per the requirements of Title II, the HHS has promulgated five rules regarding Administrative Simplification: the Privacy Rule, the Transactions and Code Sets Rule, the Security Rule, the Unique Identifiers Rule, and the Enforcement Rule. The Privacy Rule took effect on Apr. 14, 2003, it establishes regulations for the use and disclosure of Protected Health Information (PHI). PHI is any information about health status, provision of health care, or payment for health care that can be linked to an individual. This is interpreted rather broadly and includes any part of a patient's medical record or payment history.

The Security Rule complements the Privacy Rule. While the Privacy Rule pertains to all Protected Health Information (PHI) including paper and electronic, the Security Rule deals specifically with Electronic Protected Health Information (EPHI). It lays out three types of security safeguards required for compliance: administrative, physical, and technical. For each of these types, the Rule identifies various security standards, and for each standard, it names both required and addressable implementation specifications. Required specifications must be adopted and administered as dictated by the Rule. Addressable specifications are more flexible. Individual covered entities can evaluate their own situation and determine the best way to implement addressable specifications.

The standards and specifications are as follows: Procedures should clearly identify employees or classes of employees who will have access to electronic protected health information (EPHI). Access to EPHI must be restricted to only those employees who have a need for it to complete their job function. The procedures must address access authorization, establishment, modification, and termination.

In short, patient's personal record, medical or clinical data may be unintentionally viewed, displayed or transmitted as collateral information. Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

A system and method is provided for managing health care information. A data network system includes a document parser, upon request, parses a patient's record into a plurality of categorized biographical and/or clinical data entries, where each of the categorized biographical and/or clinical data entries may be associated with a code identifier. A mapper may map each of the code identifiers to a configurable patient privacy flag and to a corresponding user permission level. The patient's mapped categorized biographical and/or clinical data entries may be checked by a configurable rule engine, and be displayed to the user as viewable layers with the same or less restrictive permission level than that of the user's role. The unapproved data may be turned off as non-viewable layers. The patient's mapped biographical and/or clinical data entries may be stored into a repository database for later retrieval.

Various advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A is a block diagram of an exemplary patient document and privacy disclosure engine comprising a data network system with a patient privacy host engine communicating to a repository database, in accordance with an embodiment of the invention.

FIG. 1B is a block diagram illustrating exemplary mapping operations of patient's record by a rule engine, in accordance with an embodiment of the invention.

FIG. 1C is a block diagram illustrating an exemplary patient's record document type mapping operation prior to parsing, in accordance with an embodiment of the invention.

FIG. 1D is an exemplary patient's record document showing a portion of a patient's clinical and biographical data, in accordance with an embodiment of the invention.

FIG. 2 is a flow diagram illustrating exemplary operations performed by a patient privacy disclosure engine, in accordance with an embodiment of the invention.

FIG. 3 is a flow diagram illustrating an exemplary procedure for a patient's record query, in accordance with an embodiment of the invention.

### DETAILED DESCRIPTION OF THE INVENTION

Certain aspects of the invention may be found in a system and method for managing health care information. Exemplary aspects of the invention may comprise using a patient document privacy and disclosure engine to service a user's query for patient's record. In an embodiment, the patient's record may be retrieved in real time as one or more patient's record document from a repository database. The patient's record document may be parsed by a document parser into a plurality of categorized biographical and/or clinical data entries. Each of the biographical and/or clinical data entry may be associated with a code identifier, which in turn, may be mapped to a configurable patient privacy flag that indicates a permission level. The code identified, patient privacy flagged and permission level mapped categorized biographical and/or clinical data entries may be checked by a configurable rule engine, and approved for display to the user as viewable layers with the same or less restrictive permission level than that of the user's role. The unapproved data may be turned off as non-viewable layers. In another embodiment, the patient's record document may be pre-parsed and stored as mapped biographical and/or clinical data entries into a repository database for later retrieval in response to a user query.

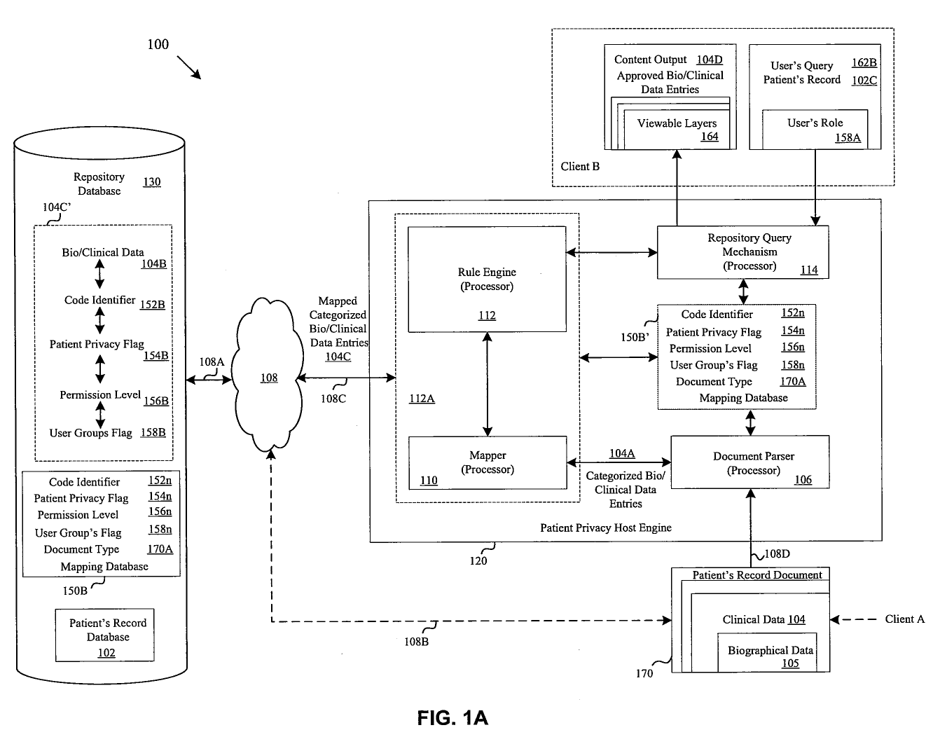

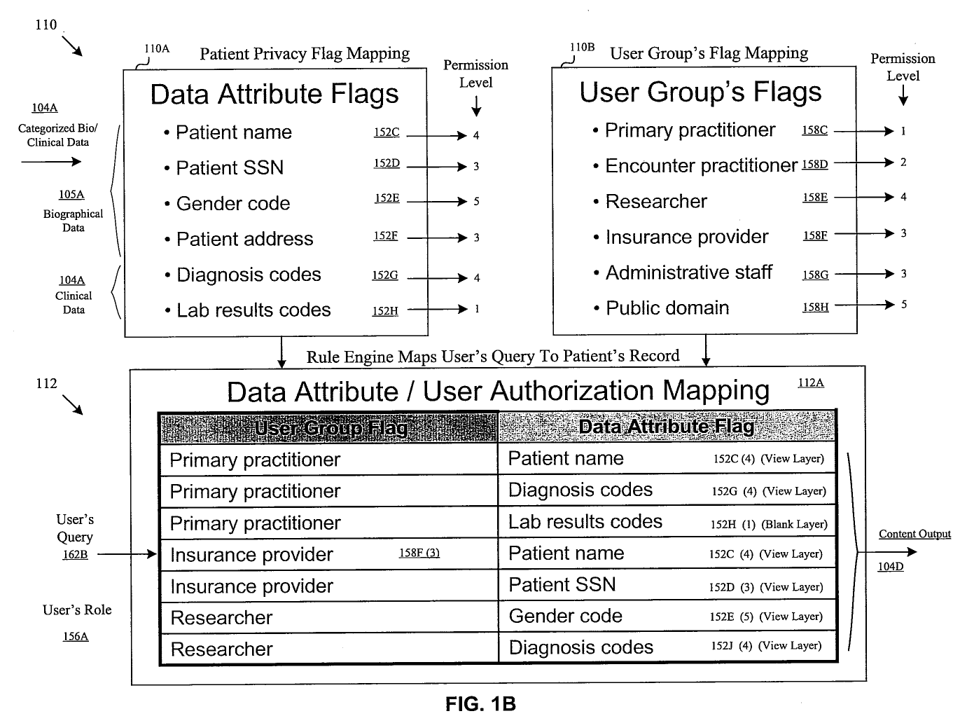

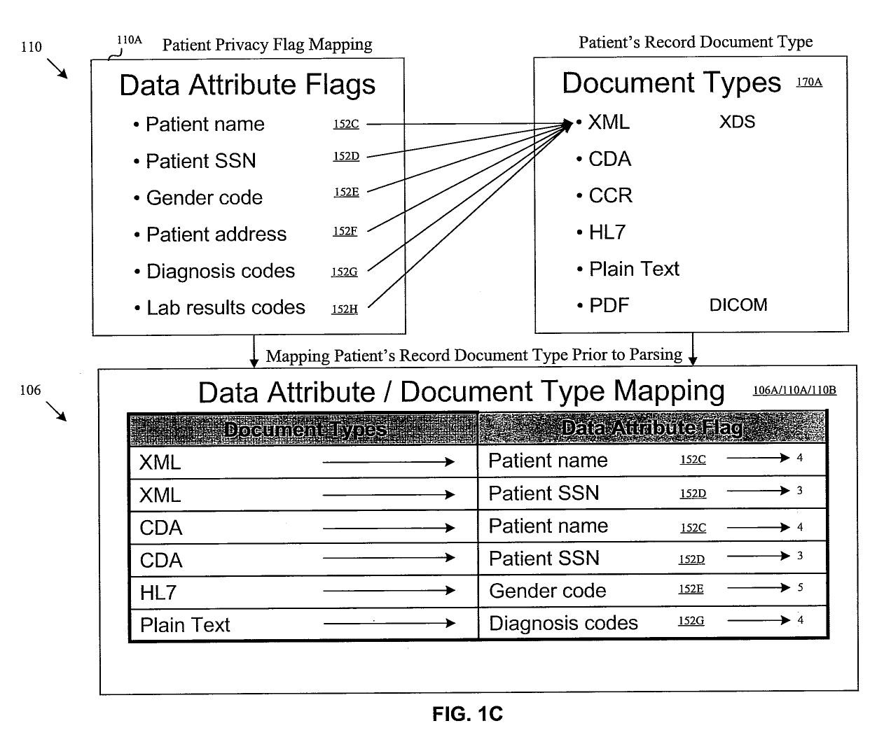

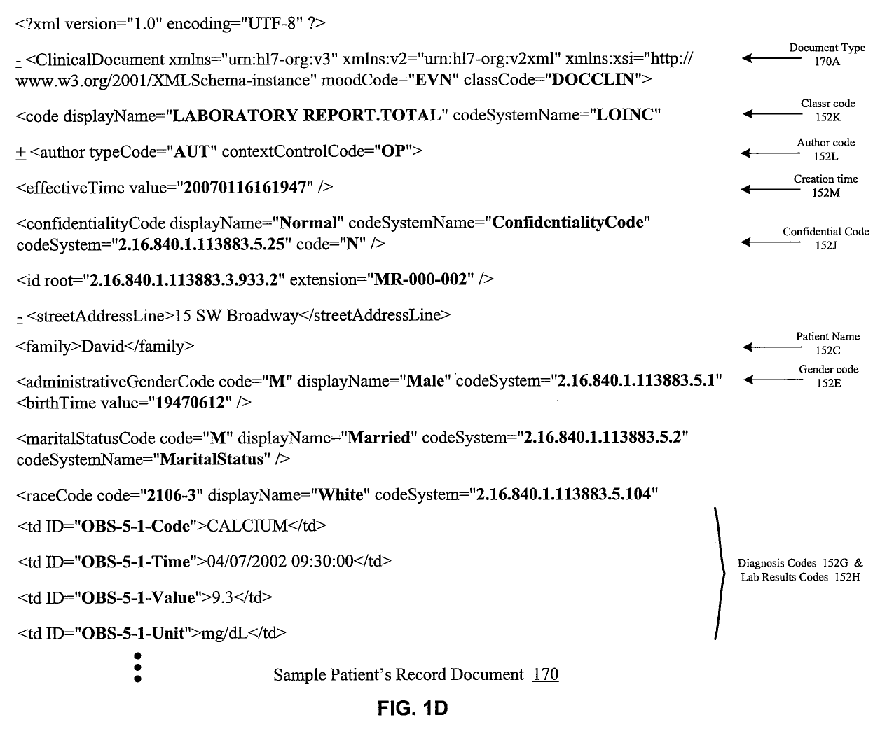

FIG. 1A is a block diagram of an exemplary patient document and privacy disclosure engine 100 comprising a data network system 108 with a patient privacy host engine 120 communicating to a repository database 130, in accordance with an embodiment of the invention. Referring to FIG. 1A, there is shown an exemplary patient document and privacy disclosure engine 100 comprising a data network system 108 such as a local area network (LAN) or a wide area network (WAN) with a plurality of network links 108A, 108B and 108C. The data network system 108 may support one or more host such as a patient privacy host engine 120 to facilitate retrieving one or more patient's record document 170 from a patient's record database 102 in the repository database 130.

In an embodiment, the patient's record document 170 may be a Cross-Enterprise Document Sharing (XDS) document, conformed to the Clinical Document Architecture (CDA), operating under Health Level 7 (HL7) standard created in eXtensible Markup Language (XML), adaptable for machine processing or parsing of clinical data 104 and biographical data 105. The CDA document may contain text, images and multimedia, coded data. In another embodiment, the patient's record may be in the form of a HL7 messaging, a Continuity Care Record (CCR) document, a plain text document or an Adobe® pdf document. In other embodiment, the patient's clinical data 104 may be a non text searchable document such as an X-ray film, or a Digital Imaging and Communication (DICOM) image document file.

The patient's record document 170 may comprise both clinical data 104 and/or biographical data 105 specific to the patient. The patient's biographical data 105 may comprise the patient's name, social security number, gender, address, and age, date of birth, race, insurance carrier, employment information and marital status. The patient's clinical data 104 may comprise the patient's height, body mass, allergies, medication and dosage, physician diagnosis record, lab test results, medical history such as past diseases, surgeries, disorders, mental history, psychiatric treatments, trauma and physician's comments etc.

In an embodiment, the patient's record document 170 may be loaded into the patient privacy host engine 120 internally via the network link 108C for real time parsing in response to a user's query 162B from a client B. In another embodiment, the patient's record document 170 may be an input entry in real-time from a client A to the patient privacy host engine 120 via the network link 108D. Yet in another embodiment, the patient's record document 170 may be an unparsed input entry saved at an earlier time from the client A, to the repository database 130.

The repository database 130 may comprise a patient's record database 102, an optional pre-parsed database 104C′ that stores pre-parsed and mapped categorized biographical and/or clinical data entries 104C, and a mapping database 150B. The patient's record database 102 comprises a plurality of initially stored unparsed patient's record document 170 for later retrieval in response to a user's query 162B. The pre-parsed database 104C′ comprises a plurality of already parsed and mapped categorized biographical and/or clinical data entries 104C, where each biographical and/or clinical data entries 104B may be pre-mapped to a code identifier 152B, which in turn may be pre-mapped to a corresponding patient privacy flag 154B, a permission level 156B and a user group's flag 158B. The mapping database 150B may comprise a database that categorizes corresponding existing mapping codes to the parsed patient's biographical or clinical data, comprising a plurality of code identifiers 152n, patient privacy flag 154n, permission level 156n, user group's flag 158n and document type 170A.

The patient privacy host engine 120 may be implemented in a combination of hardware and software, comprising one or more processors executing functions within a host computing device. The patient privacy host engine 120 may comprise a document parser 106, a mapper 110, a rule engine 112, a repository query mechanism 114 and a mapping database 150B′. In an embodiment, the patient privacy host engine 120 may carry out parsing and mapping operations separately, or jointly in conjunction with the rule engine 112. Parsing and mapping operations on the patient's record document 170 may be carried out upon receiving a user's query 162B from the client B in real-time or in non real-time. The patient privacy host engine 120 may display an approved content output 104D to the client B, in the form of a plurality of viewable layers 164, where the approved content output 104D may be printed or stored by the client B.

The document parser 106 may comprise one or more processor, suitable hardware, logic, circuitry, and/or code that may be adapted to identify the patient record document type 170A prior to parsing. The patient's record document 170 may comprise the patient's biographical data 105 and/or clinical data 104. In operation, the parsing of the patient's record document 170 may be carried out in real time upon retrieval from the patient's record database 102, or may be from an input by the client A in real time. Client A may be a health care provider, a primary care practitioner, an encounter practitioner, a researcher, or by a hospital administrative staff.

Each parsed biographical data 105 and/or clinical data 104 may be identified and categorized into a plurality of categorized biographical and/or clinical data entries 104A. For the ease of parsing, in an embodiment, the patient record document 170 may comprise java script codes format. After parsing by the document parser 106, each of the parsed biographical data 105 and/or clinical data 104 may be associated with a code identifier 152n. The code identifier 152n may comprise a set of data attribute flags, which may comprise existing standard clinical codes such as diagnosis codes and lab results codes commonly used in the health care industry. In another embodiment, the code identifier 152n may comprise custom codes assigned by a health care provider for internal control record or billing. The code identifier 152n may be updated periodically to meet the needs.

The mapping database 150B′ may be retrieved as a duplicated copy from the mapping database 150B in the repository database 130. The mapping database 150B′ may be utilized by the document parser 106, the mapper 110 the rule engine 112 and the repository query mechanism 114. The mapping database 150B′ may comprise a plurality of parameters for data mapping purposes. To list a few, the parameters in the mapping database 150B′ may comprise one or more code identifier 152n (to be implemented as data attribute flags), one or more patient privacy flags 154n, one or more permission level 156n, one or more user group's flag 154n and one or more document type 170A. The mapping database 150B′ may be utilized by the document parser 106 to identify the document type 170A prior to parsing, by the mapper 110 for mapping the parsed patient's categorized biographical and clinical data entries 104A and by the configurable rule engine 112 for evaluating the user's role 158A permission level upon a user's query 162B.

The mapper 110 may comprise one or more processor, suitable hardware, logic, circuitry, and/or code that may be adapted to map the each of the parsed, code identified, and categorized biographical and or clinical data 104A to one or more of the parameters in the mapping database 150B′. For example, each of the parsed, code identified, and categorized biographical and or clinical data 104A may be mapped to a patient privacy flag 154n to indicate the level of privacy protection to the patient's data. The patient's privacy flags 154n may be further mapped to a multi-tiered permission level 156n may indicate the level of restriction of the patient's mapped and categorized biographical and/or clinical data entries 104C, when accessed by a requester, such as the client B. In an embodiment, the mapper 110 may carry out the mapping process locally in the patient privacy host engine 120. Alternately, the mapping may be carried out remotely by a remote patient privacy host engine (not shown), through the data network 108. In an embodiment, the mapped plurality of categorized biographical and/or clinical data entries 104C may be stored as the pre-parsed database 104C′ in the repository database 130 for later retrieval.

In an embodiment, the multi-tiered permission level 156n may be an ascending or descending hierarchical structure from the most restrictive level to the least restrictive level, or vice versa. For example, a permission level 1 may represent a permission granted to access to the most restrictive, or the most protected patient's biographical and/or clinical data 104C. A permission level 5 may represent a permission granted to access to the least restrictive, or the least protected patient's biographical and/or clinical data 104C. For example, a primary practitioner as the client B may initiate a user's query 162B to view a patient's record 102C. The primary practitioner may be designated a user's role 158A, which is mapped to a permission level 1 by the rule engine 112. A permission level 1 would allow the primary practitioner to access or to view the most restrictive level of patient's mapped biographical and/or clinical data 104C. A public domain may be designated a user's role 158A, which is mapped to a permission level 5, where only the least restrictive level of the patient's mapped biographical and/or clinical data 104C may be accessed or viewed. In other words, the client B may be permitted to view the patient's mapped and categorized biographical and/or clinical data 104C up to the permission level that matches the client B's user's role 158A, or above (i.e., the less restrictive level).

The repository query mechanism 114 may be an interface comprising one or more processor, suitable hardware, logic, circuitry, and/or code that may be adapted to facilitate the user's query 162B from client B for processing by the rule engine 112. In an embodiment, the repository query mechanism 114 may invoke the rule engine 112 to trigger a retrieval of the patient's record document 170 from the repository database 130 for parsing and mapping in real time.

The configurable rule engine 112 may comprise one or more processor, suitable hardware, logic, circuitry, and/or code that may be adapted to follow a set of rules to evaluate to what permission level, the user's query 162B may have access to the patient's record. In an embodiment, the evaluation may comprise determining a user's role 158A from the user query 162B, mapping the user's role 158A to a user group's flag 158n, and mapping the user group's flag 158n to a corresponding permission level 156B. Based on the corresponding permission level 156B, the rule engine 112 may match and output at least a portion of the plurality of mapped categorized biographical data and/or clinical data entries 104C, which have the same permission level or higher (less restrictive permission level), for display as a plurality of viewable layers 164. The patient's categorized biographical and/or clinical data entries 104C, which has a more restrictive permission level may be hidden from display as non-viewable layers.

In another embodiment, the rule engine 112's evaluation steps may comprise authenticating an identity of the client B at the log in process, and to check the validity of the user's role 158A. The authentication process may comprise logging in as a valid user with a password. The configurable rule engine 112 may execute an algorithm based on a set of configurable privacy security rules based on the multi-tiered permission level hierarchy, which may be updated in accordance to the law change, or modify the permission level as needed to meet special circumstances under the guidelines consistent to HIPAA. Once log in is successful, the configurable rule engine 112 may match the user's role 158A to a permission level 156n. If the user's role 158A is not identified, or the client B is not properly logged in, client B may be denied access to the patient's data. If login is successful, but none of the patient's privacy flag 154n or code identifier 152n are found in the mapping database 150B′, only the least restrictive level 5 permission level may be used by the configurable rule engine 112.

FIG. 1B is a block diagram illustrating exemplary mapping operations of patient's record by a rule engine 112, in accordance with an embodiment of the invention. Referring to FIG. 1B, there is shown a mapper 110 performing a patient privacy flag mapping operation 110A and a user group's flag mapping operation 110B. There is also shown a configurable rule engine 112 for performing data attribute to user authorization mapping operations 112A to display a content output 104D in response to a user's query 162B, based on a user's role 158A.

In operation, the mapper 110 may receive a plurality of categorized biographical 105A and/or clinical data entries 104A from the document parser 106. The patient privacy flag mapping operation 110A may associate each of the categorized biographical 105A and/or clinical data entries 104A with a code identifier 152n, which may be implemented as corresponding data attribute flags 152C to 152H. For example, the categorized biographical data 105A such as the patient's name, the patient's social security number, the patient's gender code and the patient's address may be associated with corresponding code identifiers 152C, 152D, 152E and 152F respectively. The categorized clinical data 104A such as the diagnosis codes and lab results codes may be associated with corresponding identifier codes 152G and 152H respectively.

The corresponding data attribute flags 152C to 152H may be mapped to a permission level consistent with the rules set by the rule engine 112. For example, the patient name with the data attribute flag 152C may be mapped to a permission level 4 (on a scale of 1 to 5 with 5 being the least restrictive and 1 being the most restrictive for access). The patient's social security number with the data attribute flag 152D may be mapped to a more restrictive permission level of 3. The gender data attribute flag 152E may be mapped to the least restrictive permission level 5, the patient address data attribute flag 152E may be mapped to a permission level 3, the diagnosis code data attribute flag 152G may be mapped to a permission level 4. The lab results codes data attribute flag 152H may be mapped to the most restrictive permission level 1, since only the primary practitioner, or those who are authorized by the primary practitioner (assigned with the permission level 1) may be able to view the lab results of the specified patient.

Referring to the user group's flag mapping operation 110B, there is shown a plurality of valid users, which are identified by corresponding to respective user group's flags 158C to 158H. For example, the user's roles may correspond respective user group's flags as a primary practitioner 158C, an encounter practitioner 158D, a researcher 158E, an insurance provider 158F, an administrator staff 158G and a public domain 158H. Each of the respective user group's flags may be mapped to a corresponding permission level consistent with the rules set by the rule engine 112. For example, the primary practitioner with a user group's flag 156C may be mapped to the most restrictive permission level 1 (permitted to access the most restrictive patient's biographical and/or clinical data). The encounter practitioner, such as a specialist may have a user group's flag 158D, who may be mapped to a permission level 2, since the patient may not be under his primary care. The encounter practitioner with a permission level 2 may be reconfigured to have a permission level 1, when authorized by the primary practitioner to a specified patient. The researcher with a user group's flag 158E may be mapped to a permission level 4 (authorized to access less restrictive patient's biographical data and/or clinical data). An insurance provider with a user group's flag 158F may be mapped to a permission level 3. The public domain such as a University student may collect clinical data for a thesis may have a user group's flag 156H with a permission level 5 (access to the least restrictive level data).

The configurable rule engine operation 112A may be illustrated by an example of an insurance provider who logs into the patient document and privacy disclosure engine 100 as client B. The insurance provider may be designated to the user role 156A, and identified with the user group's flag 156F. The insurance provider may send a user's query 162B to retrieve the patient's record 102C for the purpose of payment to a health care provider. The configurable rule engine 112 may map the user group's flag 156F of the insurance provider to a permission level 3. Based on the permission level 3, the configurable rule engine 112 may retrieve from the repository database 130, the patient's record document 170 for real time parsing. After parsing, the portion of mapped and categorized biographical and/or clinical data 104C that matches a permission level 3 or higher may be displayed as the approved content output 104D in the form of viewable layers 164. According to the shown example, the insurance provider with the permission level 3 may view from the viewable layers 164 information such as the patient's name (permission level 4), the diagnosis code (permission level 4), the patient's social security number (permission level 3), the gender code (permission level 5) and the diagnosis codes 152G and 152J (permission level 4). Since the lab results with data attribute flag 152H has a permission level 1 (i.e., more restrictive than the permission level 3), the insurance provider may not be able to view the lab results as viewable layer.

FIG. 1C is a block diagram illustrating an exemplary patient's record document type mapping operation 110C prior to parsing, in accordance with an embodiment of the invention. Referring to FIG. 1C, there is shown a plurality of patient record document types 170A. To name a few, the document types 170A may be a XDS, a XML, a CDA, a CCR, a HL7, a Plain text, a PDF or a DICOM document. In an embodiment of the invention, the document parser 106 may initially identify the patient's record document type 170A prior to document parsing. For example, the document parser 106 may utilize the mapping database 150B′ to initially identify that the patient's record document 170 is of a XML document type. Subsequently, the document parser 106 may execute codes for XML document parsing, to parse the patient's name and patient's SSN. The mapper 110 may carry out mapping operations 110A and 110B to map the corresponding patient's biographical data to corresponding data attribute flags 152C and 152D, and to corresponding permission levels 4 and 3.

Likewise, other document types such as the CDA, HL7 and plain text document types may similarly be retrieved from the repository database 130 document type identification and parsing. The CDA, HL7 and plain text document types may be identified by the document parser 106 prior to patient's document parsing.

FIG. 1D is an exemplary patient's record document 170 showing a portion of a patient's clinical and biographical data, in accordance with an embodiment of the invention. Referring to FIG. 1D, there is shown a sample of retrieved patient's record document 170 from the repository database 130 for parsing. The patient's record document 170 may comprise metadata information such as the document type 170A, a class code 152K (e.g. laboratory report), an author code 152L (e.g. the person who authored the document), a creation time code 152M, a confidential code 152J (e.g. N for normal confidentiality), patient's name 152C, patient's gender code 152E and a plurality of patient's clinical lab data such as diagnosis codes 152G and lab results code 152H. As shown in FIG. 1D, the document type 170A is a CDA document coded in XML language. A document parser 106 may parse out the metadata in accordance to the various code identifiers for subsequent mapping as described in the previous figures described.

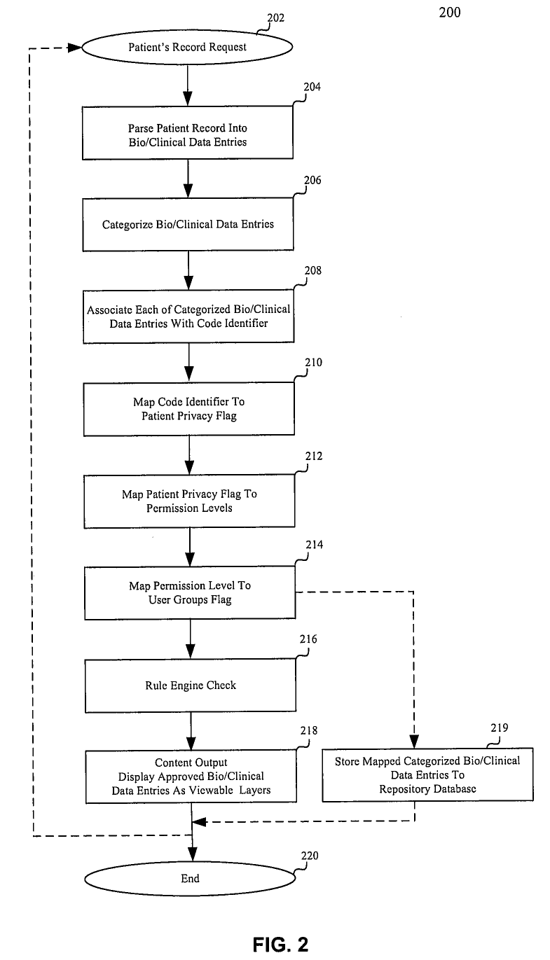

FIG. 2 is a flow diagram illustrating exemplary operations performed by a patient privacy disclosure engine, in accordance with an embodiment of the invention. Referring to FIGS. 1A and 2, there is shown in step 202, a client B may log in to a patient privacy host engine 120 to initiate a user's query 162B, including a request to retrieve a patient's record document 170 from the repository database 130. In step 204, the document parser 106 may identify the document type 170A of the retrieved patient's record document 170 and start parsing the metadata from the patient's record document 170. The metadata of the patient's record document 170 may comprise the patient's biographical data 105 and/or the clinical data 104. In step 206, the document parser 106 may send to the mapper 110 the parsed and categorized biographical and/or clinical data entries 104A. In step 208, the document parser 106 may associate each of the categorized biographical and/or clinical data entries 104A (i.e., parsed metadata) with a corresponding code identifier 152n from the mapping database 150B′. In another embodiment, the step 208 may be performed by the mapper 110. In step 210, the mapper 110 may map each of the code identifiers 152n to a plurality of corresponding data attribute flags 152C to 152H in a mapping operation 110A as illustrated in FIG. 1B. The data attribute flags 152C to 152H may be associated with the patient privacy flags 154n.

In step 212, the mapper 110 may map each of the patient privacy flag 154n to a corresponding permission level 156n. In step 214, the mapper may map the permission level 156n to a corresponding user group's flag 158n, which is identified by a user's role 158A, as part of the user's query 162B. Optionally, in another embodiment of the invention, in step 219, the parsed and mapped categorized biographical and/or clinical data entries 104C may be stored into the pre-parsed database 104C of the repository database 130 for later retrieval. In step 216, the rule engine 112 may check the access level of client B by mapping the user's role 158A to a permission level 156n from the mapping database 150B′. In step 218, the rule engine 112 may map the user's query 162B to the patient's record and output an approved content 104D display comprising biographical and/or clinical data entries as viewable layers 164. In step 220, the process may terminate, or return to step 202 to request another document for parsing from the same user's query. The flow diagram in FIG. 2 is for illustration purpose, one skilled in the art may recognize that certain steps may be reordered to yield similar results.

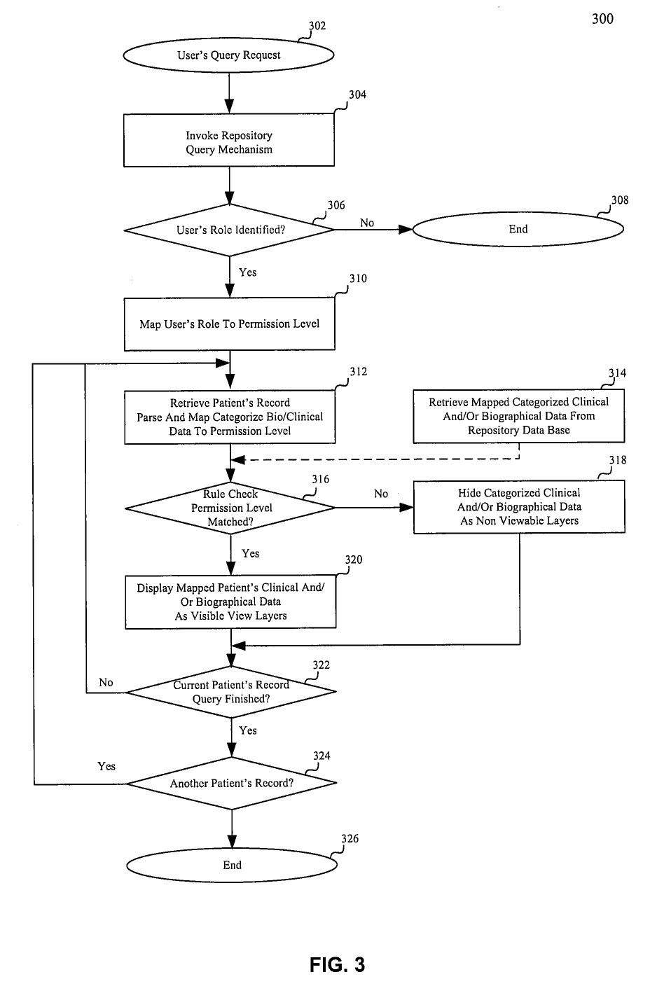

FIG. 3 is a flow diagram illustrating an exemplary procedure for a patient's record query, in accordance with an embodiment of the invention. Referring to FIGS. 1A and 3, there is shown in step 302, a client B may log in to initiate a user's query 162B to a request for a patient's record document 170 from the repository database 130. In step 304, a repository query mechanism 114 may be invoked by client B during a log in process. In step 306, the rule engine 112 may validate or identify the client B, and evaluate the user's role 158A. If the client B fails to log in, or if the user's role 158A fails to be validated or identified, the user's query 162B may terminate in step 308. If client B's log in is successful, and the user's role 158A is validated or identified, in step 310, the rule engine 112 may identify and map the user's role 158A to a permission level through the user group's flag mapping operation 110B described in FIG. 1B. In step 312, the rule engine 112 may retrieve the identified patient's record document 170 from the repository database 130. The document parser 106 may initially identify the document type 170A then start parsing in real time the retrieved patient's record document 170. The mapper 110 may map the parsed and categorized biographical and/or clinical data entries 104A to corresponding permission level 156n, as described in the mapping operations 110A and 110B in FIG. 1B.

Alternatively, in another embodiment of the invention, step 312 may be replaced by step 314, where an earlier stored pre-parsed and mapped categorized biographical and/or clinical data entries 104C, each have already been mapped to a corresponding permission level 156B, may be retrieved from the repository database 130 in response to the user query 162H.

In step 316, the rule engine 112 may match the permission level 156n of the user's role 158A against the permission level of each of the parsed and mapped categorized biographical and/or clinical data 104C. In step 318, if the permission level of the user's role 158A and the categorized biographical and/or clinical data entries 104C do not match, the rule engine 112 may hide the portion of the categorized biographical and/or clinical data entries 104C as non viewable layers (i.e., the patient's data with lower permission level are denied access). In step 320, if the permission level of the user's role 158A and the categorized biographical and/or clinical data entries 104C match (i.e., the patient's data with the same or higher permission level are granted access), the rule engine 112 may display the portion of the categorized biographical and/or clinical data as viewable layers 164. In other words, for steps 318 and 320, the user's role 158A may be associated with whether the patient's biographical and/or clinical data 104C would be viewable or would be stripped from display. In operation, the user's role 158A may identify data artifacts, i.e., the corresponding patient's data attribute flags or code identifiers 152n that may be mapped to the patient's biographical and/or clinical data 104C. Thus, the patient's biographical and/or clinical data 104C with corresponding or higher permission level than the user's role 158A may be displayed. Otherwise, the patient's biographical and/or clinical data 104C with lower permission level than the user's role 158A may be hidden from view.

In step 322, the repository query mechanism may determine if all the patient's biographical and/or clinical data 104C from the current retrieved patient's document may be finished for parsing. If unfinished, the process may repeat step 312 to continue to parse or retrieve another entry of patient's biographical and/or clinical data 104C in the record document 170, otherwise the process may proceed to step 324.

In step 324, the repository query mechanism may determine if another patient's record may need to be retrieved for parsing in the user's query 158A. If so, the process may repeat step 312 to retrieve another patient's record document 170, otherwise the process may terminate in step 326. The flow diagram in FIG. 3 is for illustration purpose, one skilled in the art may recognize that certain steps may be reordered to yield similar results.

Certain embodiments of the invention may comprise a machine-readable storage having stored thereon, a computer program having at least one code section for a document parser 106, a mapper 110 a configurable rule engine 112 and a repository database 130 to execute respective functions to parse and categorize the patient's record document 170, to map the categorized biographical and/or clinical data 104A, to store the mapped and categorized biographical and/or clinical data 104C, and to retrieve and output at least a portion of the patient's record 102C based on a user's query 162B and a user's role 158A, the at least one code section being executable by a machine for causing the machine to perform one or more of the steps described herein.

Accordingly, aspects of the invention may be realized in hardware, software, firmware or a combination thereof. The invention may be realized in a centralized fashion in at least one computer system or in a distributed fashion where different elements are spread across several interconnected computer systems. Any kind of computer system or other apparatus adapted for carrying out the methods described herein is suited. A typical combination of hardware, software and firmware may be a general-purpose computer system with a computer program that, when being loaded and executed, controls the computer system such that it carries out the methods described herein.

One embodiment of the present invention may be implemented as a board level product, as a single chip, application specific integrated circuit (ASIC), or with varying levels integrated on a single chip with other portions of the system as separate components. The degree of integration of the system will primarily be determined by speed and cost considerations. Because of the sophisticated nature of modem processors, it is possible to utilize a commercially available processor, which may be implemented external to an ASIC implementation of the present system. Alternatively, if the processor is available as an ASIC core or logic block, then the commercially available processor may be implemented as part of an ASIC device with various functions implemented as firmware.

The present invention may also be embedded in a computer program product, which comprises all the features enabling the implementation of the methods described herein, and which when loaded in a computer system is able to carry out these methods. Computer program in the present context may mean, for example, any expression, in any language, code or notation, of a set of instructions intended to cause a system having an information processing capability to perform a particular function either directly or after either or both of the following: a) conversion to another language, code or notation; b) reproduction in a different material form. However, other meanings of computer program within the understanding of those skilled in the art are also contemplated by the present invention.

While the invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiments disclosed, but that the present invention will include all embodiments falling within the scope of the appended claims.

What is claimed is:

1. A method for managing health care information, the method comprising:
parsing in a patient document privacy and disclosure engine a patient's record into a plurality of categorized biographical and/or clinical data entries;
associating each of said plurality of categorized biographical and/or clinical data entries with a code identifier;
mapping each of said code identifier to a configurable patient privacy flag, said configurable patient privacy flag is mapped to a permission level;
outputting said mapped plurality of categorized biographical and/or clinical data entries based on an evaluation of a user's query by a configurable rule engine.

2. The method according to claim 1, wherein said patient's record is retrieved from a repository database or received from an input.

3. The method according to claim 2, comprising storing each of said mapped plurality of categorized biographical and/or clinical data entries into a repository database for later retrieval.

4. The method according to claim 1, comprising mapping said code identifier to one or more of a document type, or vice versa, said document type comprises one or more of an XDS, XML, CDA, CCR, HL7, plain text, PDF or DICOM image document type.

5. The method according to claim 1, wherein said code identifier utilizes standard clinical codes from health care industry and/or custom codes assigned by a health care provider.

6. The method according to claim 1, wherein said code identifier comprises metadata linked to said mapped plurality of categorized biographical and/or clinical data entries.

7. The method according to claim 1 comprising a multi-tiered permission level hierarchy established from a plurality of said permission levels, with the most restrictive level to the least restrictive level, or vice versa.

8. The method according to claim 1 comprising evaluating said user's query via said configurable rule engine, said evaluating comprising:
determining a user's role from said user query;
mapping said user's role to a user group's flag;
mapping said user group's flag to said corresponding permission level; and
outputting said at least a portion of patient's record from said plurality of mapped categorized biographical data and/or clinical data entries based on said user's role.

9. The method according to claim 1 comprising reconfiguring said rule engine with one or more updates from law changes in Health Insurance Portability and Accountability Act (HIPAA), new codes, user's role or permission level.

10. The method according to claim 1, wherein said outputting comprises approved content and unapproved content, said approved content comprises at least a portion of said mapped plurality of categorized biographical data and/or clinical data entries as one or more viewable layer, and said unapproved content comprises one or more non viewable layers.

11. A system for managing health care information, the system comprising:
one or more processors executing functions within a host computing device as a patient privacy and disclosure engine, wherein said functions comprising:
parsing a patient's record into a plurality of categorized biographical and/or clinical data entries;
associating each of said plurality of categorized biographical and/or clinical data entries with a code identifier;
mapping each of said code identifier to a configurable patient privacy flag, said configurable patient privacy flag is mapped to a permission level;
outputting said mapped plurality of categorized biographical and/or clinical data entries based on an evaluation of a user's query by a configurable rule engine.

12. The system according to claim 11, wherein said patient's record is retrieved from a repository database or received from an input.

13. The system according to claim 12, comprising storing each of said mapped plurality of categorized biographical and/or clinical data entries into a repository database for later retrieval.

14. The system according to claim 11, comprising mapping said code identifier to one or more of a document type, or vice versa, said document type comprises one or more of an XDS, XML, CDA, CCR, HL7, plain text, PDF or DICOM image document type.

15. The system according to claim 11, wherein said code identifier utilizes standard clinical codes from health care industry and/or custom codes assigned by a health care provider.

16. The system according to claim 11, wherein said code identifier comprises metadata linked to said mapped plurality of categorized biographical and/or clinical data entries.

17. The system according to claim 11, comprising a multi-tiered permission level hierarchy established from a plurality of said permission levels, with the most restrictive level to the least restrictive level, or vice versa.

18. The system according to claim 11, comprising evaluating said user's query via said configurable rule engine, said evaluating comprising:
determining a user's role from said user query;
mapping said user's role to a user group's flag;
mapping said user group's flag to said corresponding permission level; and
outputting said at least a portion of patient's record from said plurality of mapped categorized biographical data and/or clinical data entries based on said user's role.

19. The system to according to claim 11, comprising reconfiguring said rule engine with one or more updates from law changes in Health Insurance Portability and Accountability Act (HIPAA), new codes, user's role or permission level.

20. The system to according to claim 11, wherein said outputting comprises approved content and unapproved content, said approved content comprises at least a portion of said mapped plurality of categorized biographical data and/or clinical data entries as one or more viewable layer, and said unapproved content comprises one or more non viewable layers.
